(19) United States
(12) Patent Application Publication
(10) Pub. No.: US 2017/0078742 A1
(43) Pub. Date: Mar. 16, 2017

(54) METHOD AND APPARATUS FOR VIDEO PROCESSING

(71) Applicant: Nokia Technologies Oy, Espoo (FI)

(72) Inventors: Kongqiao Wang, Helsinki (FI); Xiaoyang Liu, Beijing (CN); Wendong Wang, Beijing (CN)

(21) Appl. No.: 15/123,237

(22) PCT Filed: Mar. 10, 2014
(86) PCT No.: PCT/CN2014/073120

§ 371 Date: Sep. 1, 2016

(51) Int. Cl. H04N 21/442; G06K 9/00; H04N 21/8549; G06F 3/01

(52) U.S. Cl. CPC H04N 21/44218; G06F 3/013; G06K 9/0061; G06K 9/00744; H04N 21/8549

(57) ABSTRACT

There are disclosed various methods for video processing in a device and an apparatus for video processing. In a method one or more frames of a video are displayed to a user and information on an eye of the user is obtained. The information on the eye of the user is used to determine one or more key frames among the one or more frames of the video; and to determine one or more objects of interest in the one or more key frames. An apparatus comprises a display for displaying one or more frames of a video to a user; an eye tracker for obtaining information on an eye of the user; a key frame selector configured for using the information on the eye of the user to determine one or more key frames among the one or more frames of the video; and an object of interest determiner configured for using the information on the eye of the user to determine one or more objects of interest in the one or more key frames.

### TECHNICAL FIELD

The present invention relates to a method for video processing in a device and an apparatus for video processing.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Video summary for browsing, retrieval, and storage of video is becoming more and more popular. Some video summarization techniques produce summaries by analyzing the underlying content of a source video stream, and condensing this content into abbreviated descriptive forms that represent surrogates of the original content embedded within the video. Some solutions can be classified into two categories, static video summarization and dynamic video skimming. Static video summarization may consist of several key frames, while dynamic video summaries may be composed of a set of thumbnail movies with or without audio extracted from the original video.

An issue is to find a computational model that may automatically assign priority levels to different segments of media streams. Since users are the end customer and evaluators of video content and summarization, it is natural to develop computational models which may take user's emotional behavior into account, so it may be able to establish links between low-level media features and high-level semantics, and represent user's interests and attention to the video for the purpose of abstracting and summarizing redundant video data. In addition, some works on the field of video summarization focus on low frame-level processing.

### SUMMARY

Various embodiments provide a method and apparatus for generating object-level video summarization by taking user's emotional behavior data into account. In an example embodiment object-level video summarization may be generated using user's eye information. For example, user's eye behavior information may be collected, including pupil diameter (PD), gaze point (GP) and eye size (ES) for some or all frames in a video presentation. Key frames may also be selected on the basis of user's eye behavior.

Various aspects of examples of the invention are provided in the detailed description.

According to a first aspect, there is provided a method comprising:
displaying one or more frames of a video to a user;
obtaining information on an eye of the user;
using the information on the eye of the user to determine one or more key frames among the one or more frames of the video; and
using the information on the eye of the user to determine one or more objects of interest in the one or more key frames.

According to a second aspect, there is provided an apparatus comprising at least one processor and at least one memory including computer program code, the at least one memory and the computer program code configured to, with the at least one processor, causes the apparatus to:
display one or more frames of a video to a user;
obtain information on an eye of the user;
use the information on the eye of the user to determine one or more key frames among the one or more frames of the video; and
use the information on the eye of the user to determine one or more objects of interest in the one or more key frames.

According to a third aspect, there is provided a computer program product embodied on a non-transitory computer readable medium, comprising computer program code configured to, when executed on at least one processor, causes an apparatus or a system to:
display one or more frames of a video to a user;
obtain information on an eye of the user;
use the information on the eye of the user to determine one or more key frames among the one or more frames of the video; and
use the information on the eye of the user to determine one or more objects of interest in the one or more key frames.

According to a fourth aspect, there is provided an apparatus comprising:
a display for displaying one or more frames of a video to a user;
an eye tracker for obtaining information on an eye of the user;
a key frame selector configured for using the information on the eye of the user to determine one or more key frames among the one or more frames of the video; and
an object of interest determiner configured for using the information on the eye of the user to determine one or more objects of interest in the one or more key frames.

According to a fifth aspect, there is provided an apparatus comprising:
means for displaying one or more frames of a video to a user;
means for obtaining information on an eye of the user;
means for using the information on the eye of the user to determine one or more key frames among the one or more frames of the video; and
means for using the information on the eye of the user to determine one or more objects of interest in the one or more key frames.

### BRIEF DESCRIPTION OF THE DRAWINGS

For a more complete understanding of example embodiments of the present invention, reference is now made to the following descriptions taken in connection with the accompanying drawings in which:

FIG. 1 shows a block diagram of an apparatus according to an example embodiment;

FIG. 2 shows an apparatus according to an example embodiment;

FIG. 3 shows an example of an arrangement for wireless communication comprising a plurality of apparatuses, networks and network elements;

FIG. 4 shows a simplified block diagram of an apparatus according to an example embodiment;

FIG. 5 shows an example of an arrangement for acquisition of eye data;

FIG. 6 shows an example of spatial and temporal object of interest plane as a highlighted summary in a video;

FIG. 7 shows an example of a general emotional sequence corresponding to the video;

FIG. 8 shows an example of an acquisition of an object of interest; and

FIG. 9 depicts a flow diagram of a method according to an embodiment.

### DETAILED DESCRIPTION OF SOME EXAMPLE EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

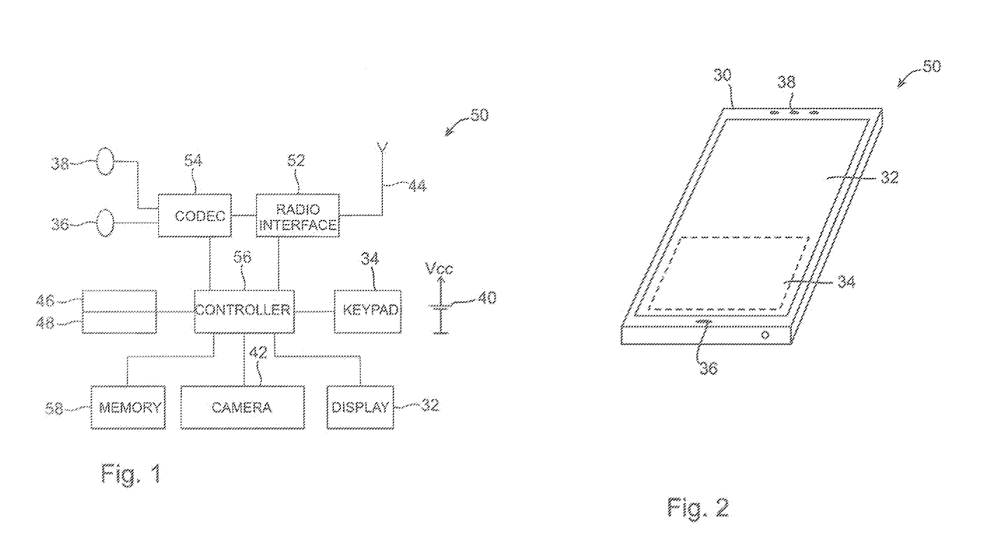

The following describes in further detail an example of a suitable apparatus and possible mechanisms for implementing embodiments of the invention. In this regard reference is first made to FIG. 1 which shows a schematic block diagram of an exemplary apparatus or electronic device 50 depicted in FIG. 2, which may incorporate a receiver front end according to an embodiment of the invention.

The electronic device 50 may for example be a mobile terminal or user equipment of a wireless communication system. However, it would be appreciated that embodiments of the invention may be implemented within any electronic device or apparatus which may require reception of radio frequency signals.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 102 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting images.

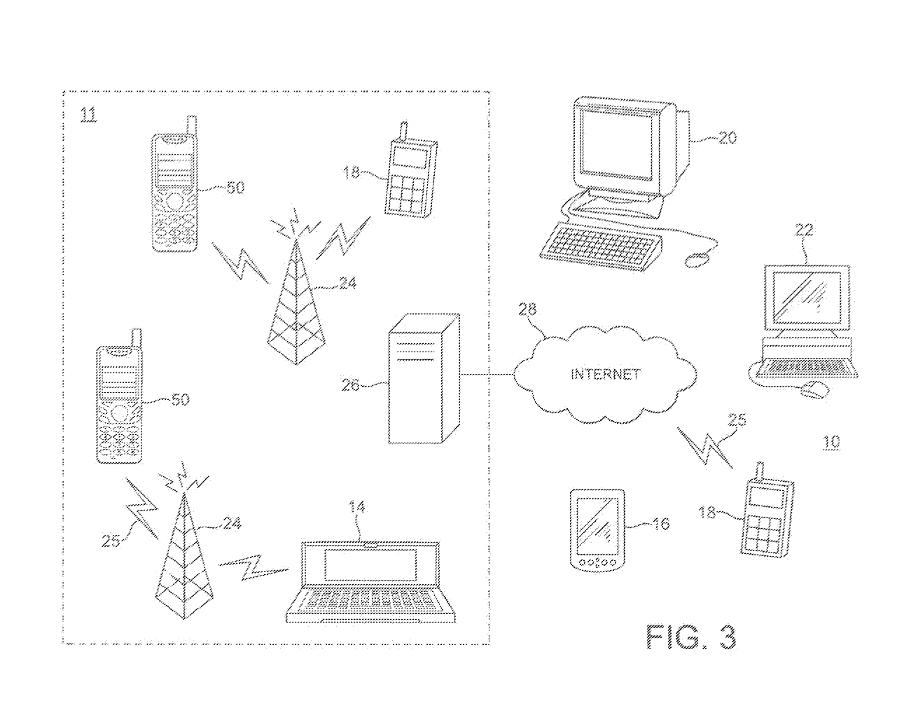

With respect to FIG. 3, an example of a system within which embodiments of the present invention can be utilized is shown. The system 10 comprises multiple communication devices which can communicate through one or more networks. The system 10 may comprise any combination of wired and/or wireless networks including, but not limited to a wireless cellular telephone network (such as a GSM, UMTS, CDMA network etc.), a wireless local area network (WLAN) such as defined by any of the IEEE 802.x standards, a Bluetooth personal area network, an Ethernet local area network, a token ring local area network, a wide area network, and the Internet.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

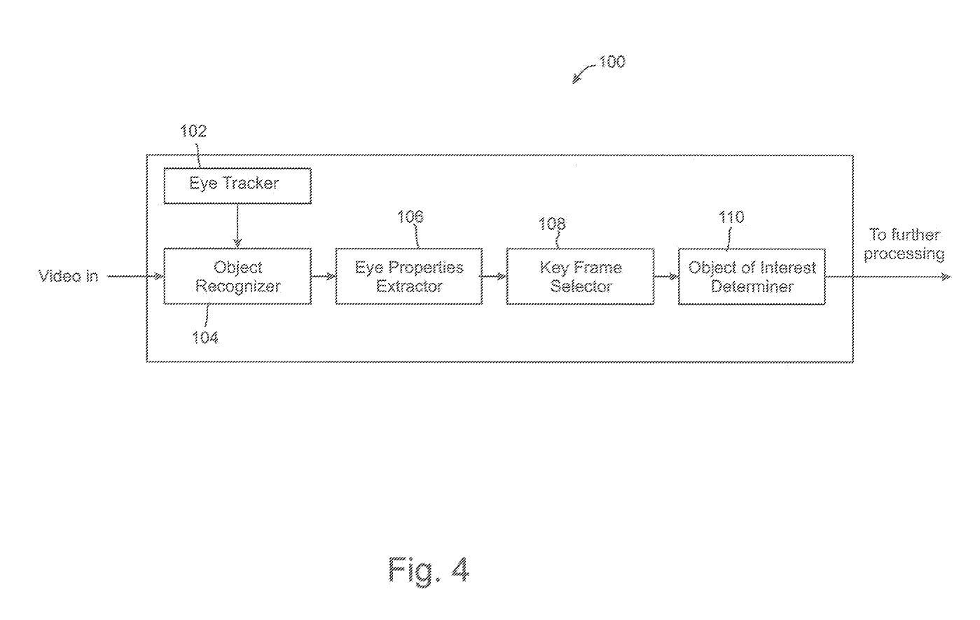

In the following some example implementations of apparatuses and methods will be described in more detail with reference to FIGS. 4 to 8.

According to an example embodiment object-level video summarization may be generated using user's eye information. For example, user's eye behavior information may be collected, including pupil diameter (PD), gaze point (GP) and eye size (ES) for some or all frames in a video presentation. That information may be collected e.g. by an eye tracking device which may comprise a camera and/or may utilize infrared rays which are directed towards the user's face. Infrared rays reflected from the user's eye(s) may be detected. Reflections may occur from several points of the eyes wherein these different reflections may be analyzed to determine the gaze point. In an embodiment the separate eye tracking device is not needed but a camera of the device which is used to display the video, such as a mobile communication device, may be utilized for this purpose.

Calibration of the eye tracking functionality may be needed before the eye tracking procedure because different users may have different eye properties. It may also be possible to use more than one camera to track the user's eyes.

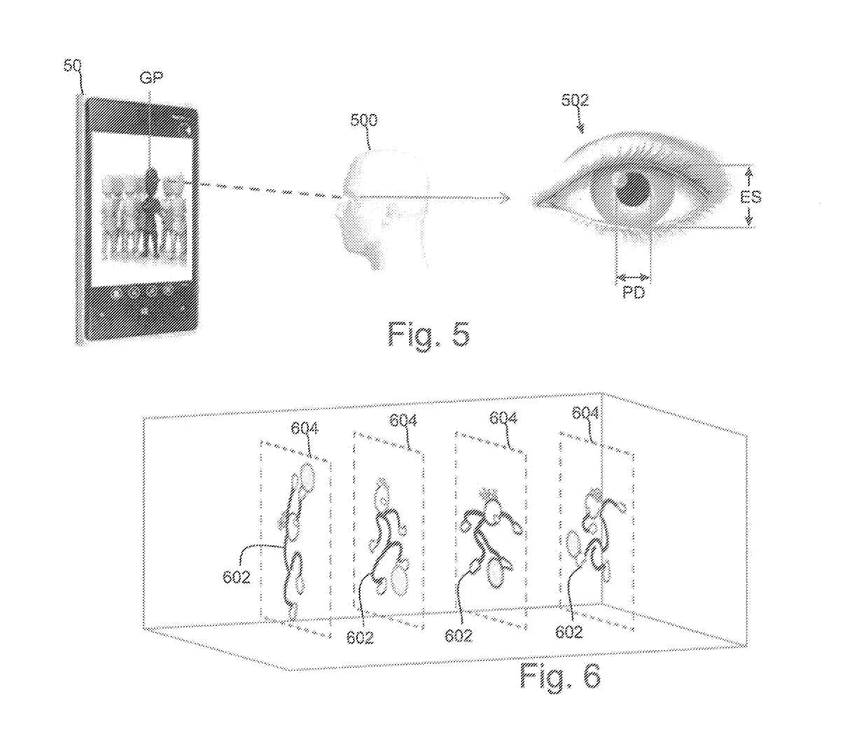

In the camera based technology images of the user's face may be captured by the camera. This is depicted as Block 902 in the flow diagram of FIG. 9. Captured images may then be analyzed 904 to locate the eyes 502 of the user 500. This may be performed e.g. by a suitable object recognition method. When the user's eye 502 or eyes have been detected from the image(s), information regarding the user's eye may be determined 906. For example, the pupil diameter may be estimated as well as the eye size and the gaze point. The eye size may be determined by estimating the distance between the upper and lower eyelid of the user, as is depicted in FIG. 5. It may be assumed that the bigger the pupil (eye) is, the higher the user's emotional level is. FIG. 5 depicts an example of the acquisition of user's 500 eye information. Thus, emotional level of the user 500 to the content of the current frame may be obtained by analyzing the properties of the user's eye. Then by collecting emotional level data from more than one frame of the video, an emotional level sequences for the video may be obtained. So, it may be deduced that the frame with higher emotional value is the frame user gets more interested than the others, and they may be defined 908 as key frames in the video.

The gaze point can be used to determine 910 which object or objects of the frames the user is looking at. These objects may be called as objects of interest (OOI). FIG. 6 depicts an example where an object of interest 602 has been detected from some of the frames 604 of the video. These objects of interest may be used to generate a personalized object-level video summary.

In order to generate general object-level video summary, more eye information of different users from the same video may be needed. In this way, personal eye data may be normalized in order to get a rational key frame, since different persons may have different pupil diameter and eye size. The object with the maximum number of gaze points may be extracted as the object of interest in the key frame. That is to say, the extracted object not only may attract attention of more than one user, but may also arouse higher emotional response.

A poster-like video summarization may also be generated which consists of several objects of interest in different key frames. Furthermore, a spatial and temporal object of interest plane may also be generated in one shot as is highlighted in the video as shown in FIG. 6.

It may also be possible to temporally segment a video into two or more segments. Hence, it may also be possible to get one or more key frames for each segmentation.

The example embodiment presented above uses pupil diameter and eye size to obtain user's emotional level and uses gaze point to obtain the object of interest in the key frames. By using these information, object-level video summarization may be generated which is highly condensed not only in spatial and temporal domain, but also in content domain.

In the following, an example method for calculating emotional level data is described in more detail. The calculation may be performed e.g. as follows. It may first be assumed that there are M users and N frames of the video. In order to get the emotional level values of the user, an average pupil diameter (PDᵢ) may be calculated. An average eye size (ESᵢ) of both eyes for frame Fᵢ (i=1, 2, . . . , N) may also be calculated. The emotional value Eᵢⱼ of frame Fᵢ for user Uⱼ (j=1, 2, . . . , M) may then be obtained by using the following equation:

Eᵢⱼ=αPDᵢⱼ+βESᵢⱼ (1)

where α and β are weights for each feature.

Then each Eᵢⱼ for the same user may be normalized to a certain value range, such as [0,1], since different persons may have different pupil diameter and eye size. The normalized emotional value is notated as Eᵢⱼ′. For each frame, the emotional value (Eᵢ′) may be calculated for all users by the following equation:

$${E}_{i}^{′} = \frac{{\sum }_{j = 1}^{M} {E}_{ij}^{′}}{M} \qquad ( 2 )$$

Thus, for all the frames in the video, a general emotional sequence E for the video may be produced by

E={E₁′, E₂′, . . . , E_{N}′} (3)

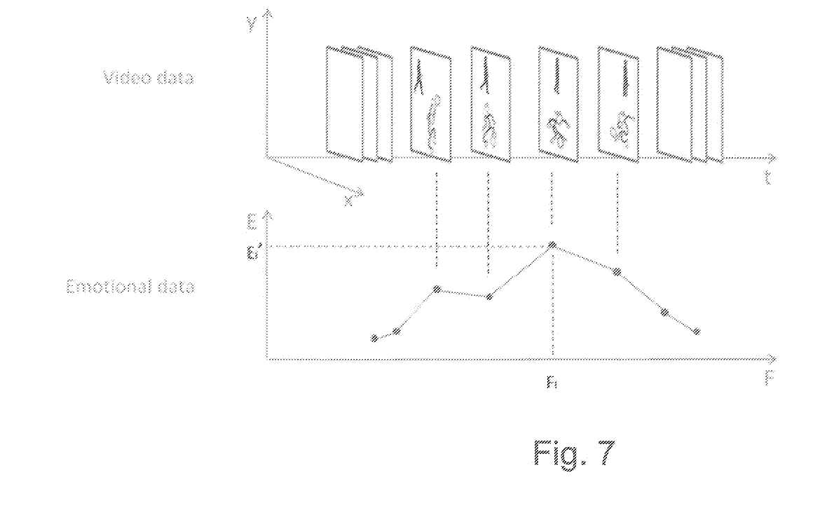

FIG. 7 shows an example of the final general emotional sequence E corresponding to the video.

An object of interest may be extracted as follows. When proceeding extraction of the object which users pay most attention to, M users' gaze points for the frame Fᵢ may be calculated. It may be assumed that the set of gaze points is

Gᵢ={Gᵢ₁, Gᵢ₂, . . . , G_{iM}} (4)

where Gᵢⱼ=(xᵢⱼ, yᵢⱼ) and Gᵢⱼ is the gaze point of user j in frame i.

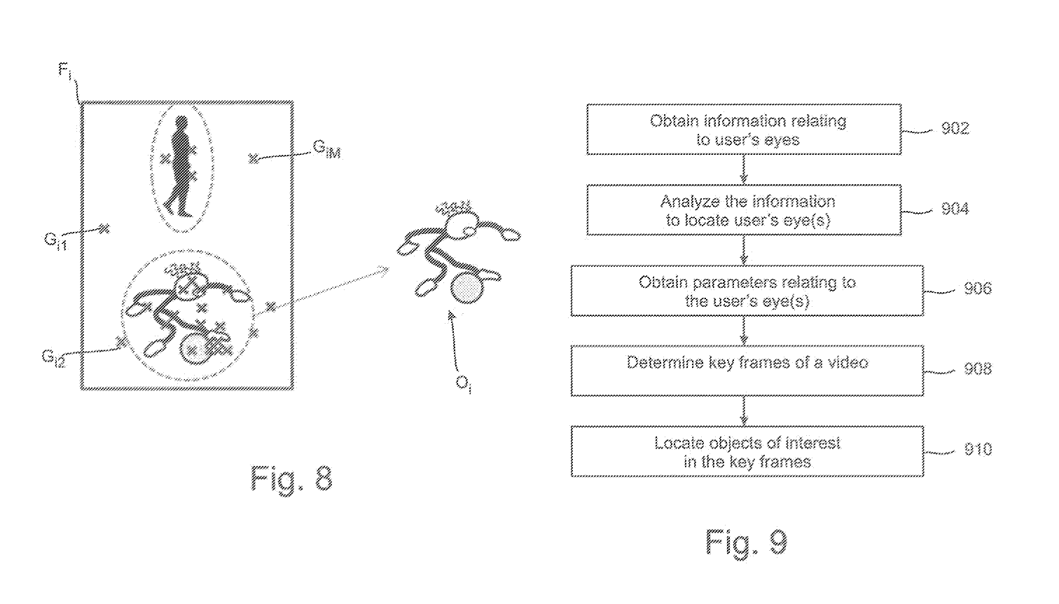

Then video content segmentation may be applied to extract some or all foreground objects and calculate the region for each valid object. The object of interest (Oᵢ) in the frame i may then be determined to be the object which contains the most gaze points in the set Gᵢ as shown in FIG. 8.

Additionally, if there are no objects extracted from the frame or the background contains the most gaze points in set Gᵢ, it may be considered that no objects of interest exists in the frame.

A video summarization may be constructed e.g. as follows. After the calculation of the emotional sequence for the whole video, it may be used to generate the key frame for each video segment by applying temporal video segmentation, e.g. shot segmentation. Now, it is assumed that the video can be divided into L segments. Thus, the key frame of k-th video segment Sₖ is the frame with maximum emotional value in this segment, notated as KFₖ. The emotional value for the key frame may be considered to be the emotional value for segment Sₖ, notated as SEₖ.

SEₖMAX{Eₐ′, Eₐ₊₁, . . . , E_{b}′} (5)

where Sₖ={Fₐ, Fₐ₊₁, . . . , F_{b}}

Then, the segment with maximum SE may be selected as the highlight segment of the video. And by applying the above described procedure of the extraction of the object of interest, the object of interest in the key frame of the highlight segment of the video may further be obtained. This object may be considered to represent the object what users pay most attention to in the whole video. To generate an object-level video summary, a spatial and temporal object of interest plane for this object may be obtained during the corresponding video segment to demonstrate the highlight of the video as showed in FIG. 4. So the video may be highly condensed not only in the spatial and temporal domain, but also in the content domain.

Furthermore, it may also be possible to select several objects of interest from different segments which has higher emotional value than others of the video and to combine these objects into one spatial and temporal object of interest plane to demonstrate the objects which have more impact on people's emotional state in the whole video.

The above described example embodiment uses external emotional behavior data like pupil diameter to measure the degree of interest in the video content. Since a user may be the end customer of the video content, this solution may be better than the solution which only analyzes internal information that is sourced directly from the video stream. By using user's gaze points, it may be possible to generate an object-level video summary which is highly condensed not only in spatial and temporal domain, but also in content domain.

FIG. 4 shows a block diagram of an apparatus 100 according to an example embodiment. In this non-limiting example embodiment the apparatus 100 comprises an eye tracker 102 which may track user's eyes and provide tracking information to an object recognizer 104. The object recognizer 104 may search the eye or eyes of the user from the information provided by the eye tracker 102 and provides information regarding the user's eye to an eye properties extractor 106. The eye properties extractor 106 examines the information on the user's eye and determines parameters relating to the eye such as the pupil's diameter, the gaze point and/or the size of the eye. This information may be provided to a key frame selector 110. The key frame selector 110 may then select from the video information such frame or frames which may be categorized as a key frame or key frames, as was described above. Information on the selected key frame(s) may be provided to an object of interest determiner 108, which may then use information relating to the key frames and search object(s) of interest from the key frames and provide this information to possible further processing.

Some or all of the elements depicted in FIG. 4 may be implemented as a computer code and stored into a memory 58, wherein when executed by a processor 56 the computer code may cause the apparatus 100 to perform the operations of the elements as described above.

It may also be possible to implement some of the elements of the apparatus 100 of FIG. 4 using special circuitry. For example, the eye tracker 102 may comprise one or more cameras, infrared based detection systems etc.

Although the above examples describe embodiments of the invention operating within a wireless communication device, it would be appreciated that the invention as described above may be implemented as a part of any apparatus comprising a circuitry in which properties of user's eye may be utilized to determine objects of interest in a video. Thus, for example, embodiments of the invention may be implemented in a TV, in a computer such as a desktop computer or a tablet computer, etc.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

In the following some examples will be provided.

According to a first example, there is provided a method comprising:

displaying one or more frames of a video to a user;

obtaining information on an eye of the user;

using the information on the eye of the user to determine one or more key frames

among the one or more frames of the video; and

using the information on the eye of the user to determine one or more objects of interest in the one or more key frames.

In some embodiments of the method obtaining information on an eye of the user comprises:
obtaining pupil diameter, gaze point and eye size for at least one frame of the video.

In some embodiments the method comprises:
using at least one of the pupil diameter, gaze point and eye size to define an emotional value for the frame.

In some embodiments the method comprises at least one of:
providing the higher emotional value the larger is the pupil diameter; and
providing the higher emotional value the larger is the eye size.

In some embodiments of the method defining the emotional value for the frame comprises:
obtaining an emotional value Eᵢⱼ of a frame Fᵢ for a user Uⱼ (j=1, 2, . . . , M) by weighting the pupil diameter of the user by a first weight factor α, weighting the eye size of the user by a second weight factor β, and forming a sum of the results of the multiplications.

In some embodiments the method further comprises:
normalizing the emotional value Eᵢⱼ of each user to obtain a normalized emotional value Eᵢⱼ′ for each user;
calculating an emotional value Eᵢ′ for each frame by summing the normalized emotional values and dividing the sum by the number of users; and
producing a general emotional sequence E for the video from the emotional values of the frames of the video.

In some embodiments the method comprises:
determining an object of interest from the key frame.

In some embodiments the method comprises:
generating a personalized object-level video summary by using information of the objects of interest.

According to a second example there is provided an apparatus comprising at least one processor and at least one memory including computer program code, the at least one memory and the computer program code configured to, with the at least one processor, causes the apparatus to:
display one or more frames of a video to a user;
obtain information on an eye of the user;
use the information on the eye of the user to determine one or more key frames among the one or more frames of the video; and
use the information on the eye of the user to determine one or more objects of interest in the one or more key frames.

In an embodiment of the apparatus said at least one memory stored with code thereon, which when executed by said at least one processor, causes the apparatus to:
obtain pupil diameter, gaze point and eye size for at least one frame of the video.

In an embodiment of the apparatus said at least one memory stored with code thereon, which when executed by said at least one processor, causes the apparatus to:

use at least one of the pupil diameter, gaze point; eye size and an average of a size of both eyes to define an emotional value for the frame.

In an embodiment of the apparatus said at least one memory stored with code thereon, which when executed by said at least one processor, causes the apparatus to perform at least one of:
providing the higher emotional value the larger is the pupil diameter; and
providing the higher emotional value the larger is the eye size.

In an embodiment of the apparatus said at least one memory stored with code thereon, which when executed by said at least one processor, causes the apparatus to define the emotional value for the frame by:
obtaining an emotional value Eᵢⱼ of a frame Fᵢ for a user Uⱼ (j=1, 2, . . . , M) by weighting the pupil diameter of the user by a first weight factor α, weighting the eye size of the user by a second weight factor β, and forming a sum of the results of the multiplications.

In an embodiment of the apparatus said at least one memory stored with code thereon, which when executed by said at least one processor, causes the apparatus to:
normalizing the emotional value Eᵢ′ of each user to obtain a normalized emotional value Eᵢⱼ′ for each user;
calculating an emotional value Eⱼ′ for each frame by summing the normalized emotional values and dividing the sum by the number of users; and
producing a general emotional sequence E for the video from the emotional values of the frames of the video.

In an embodiment of the apparatus said at least one memory stored with code thereon, which when executed by said at least one processor, causes the apparatus to:
determine an object of interest from the key frame.

In an embodiment of the apparatus said at least one memory stored with code thereon, which when executed by said at least one processor, causes the apparatus to:
obtain information of one or more gaze points the user is looking at;
examine which object is located on the display at said one or more gaze points; and
select the object as the object of interest located at one or more of said gaze points.

In an embodiment of the apparatus said at least one memory stored with code thereon, which when executed by said at least one processor, causes the apparatus to:
generate a personalized object-level video summary by using information of the objects of interest.

According to a third example, there is provided a computer program product embodied on a non-transitory computer readable medium, comprising computer program code configured to, when executed on at least one processor, causes an apparatus or a system to:
display one or more frames of a video to a user;
obtain information on an eye of the user;
use the information on the eye of the user to determine one or more key frames among the one or more frames of the video; and
use the information on the eye of the user to determine one or more objects of interest in the one or more key frames.

In an embodiment of the computer program product said computer program code, which when executed by said at least one processor, causes the apparatus or system to:
obtain pupil diameter, gaze point and eye size for at least one frame of the video.

In an embodiment of the computer program product said computer program code, which when executed by said at least one processor, causes the apparatus or system to:
use at least one of the pupil diameter, gaze point; eye size and an average of a size of both eyes to define an emotional value for the frame.

In an embodiment of the computer program product said computer program code, which when executed by said at least one processor, causes the apparatus or system to perform at least one of:
providing the higher emotional value the larger is the pupil diameter; and
providing the higher emotional value the larger is the eye size.

In an embodiment of the computer program product said computer program code, which when executed by said at least one processor, causes the apparatus or system to define the emotional value for the frame by:
obtaining an emotional value Eᵢⱼ of a frame Fᵢ for a user Uⱼ (j=1, 2, . . . , M) by weighting the pupil diameter of the user by a first weight factor α, weighting the eye size of the user by a second weight factor β, and forming a sum of the results of the multiplications.

In an embodiment of the computer program product said computer program code, which when executed by said at least one processor, causes the apparatus or system to:
normalize the emotional value Eᵢⱼ of each user to obtain a normalized emotional value Eᵢⱼ′ for each user;
calculate an emotional value Eᵢ′ for each frame by summing the normalized emotional values and dividing the sum by the number of users; and
produce a general emotional sequence E for the video from the emotional values of the frames of the video.

In an embodiment of the computer program product said computer program code, which when executed by said at least one processor, causes the apparatus or system to:
determine an object of interest from the key frame.

In an embodiment of the computer program product said computer program code, which when executed by said at least one processor, causes the apparatus or system to:
obtain information of one or more gaze points the user is looking at;
examine which object is located on the display at said one or more gaze points; and
select the object as the object of interest located at one or more of said gaze points.

In an embodiment of the computer program product said computer program code, which when executed by said at least one processor, causes the apparatus or system to:
generate a personalized object-level video summary by using information of the objects of interest.

According to a fourth example, there is provided an apparatus comprising:
a display for displaying one or more frames of a video to a user;
an eye tracker for obtaining information on an eye of the user;
a key frame selector configured for using the information on the eye of the user to determine one or more key frames among the one or more frames of the video; and
an object of interest determiner configured for using the information on the eye of the user to determine one or more objects of interest in the one or more key frames.

In an embodiment of the apparatus the eye tracker is configured to obtain information on an eye of the user by:
obtaining pupil diameter, gaze point and eye size for at least one frame of the video.

In an embodiment of the apparatus the key frame selector is configured to use at least one of the pupil diameter, gaze point; eye size and an average of a size of both eyes to define an emotional value for the frame.

In an embodiment of the apparatus the key frame selector is configured to perform at least one of:
providing the higher emotional value the larger is the pupil diameter; and
providing the higher emotional value the larger is the eye size.

In an embodiment of the apparatus the key frame selector is configured to define the emotional value for the frame by:
obtaining an emotional value Eᵢⱼ of a frame Fᵢ for a user Uᵢ (j=1, 2, . . . , M) by weighting the pupil diameter of the user by a first weight factor α, weighting the eye size of the user by a second weight factor β, and forming a sum of the results of the multiplications.

In an embodiment of the apparatus the key frame selector is further configured to:
normalize the emotional value Eᵢⱼ of each user to obtain a normalized emotional value Eᵢⱼ′ for each user;
calculate an emotional value Eᵢ′ for each frame by summing the normalized emotional values and dividing the sum by the number of users; and
produce a general emotional sequence E for the video from the emotional values of the frames of the video.

In an embodiment of the apparatus the object of interest determiner is configured to determine an object of interest from the key frame.

In an embodiment of the apparatus the key frame selector is configured to obtain information of one or more gaze points the user is looking at; and the object of interest determiner is configured to examine which object is located on the display at said one or more gaze points and to select the object as the object of interest located at one or more of said gaze points.

In an embodiment the apparatus is further configured to generate a personalized object-level video summary by using information of the objects of interest.

According to a fifth example, there is provided an apparatus comprising:
means for displaying one or more frames of a video to a user;
means for obtaining information on an eye of the user;
means for using the information on the eye of the user to determine one or more key frames among the one or more frames of the video; and
means for using the information on the eye of the user to determine one or more objects of interest in the one or more key frames.

In an embodiment of the apparatus the means for obtaining information on an eye of the user comprises means for obtaining pupil diameter, gaze point and eye size for at least one frame of the video.

In an embodiment the apparatus comprises means for using at least one of the pupil diameter, gaze point; eye size and an average of a size of both eyes to define an emotional value for the frame.

In an embodiment the apparatus further comprises at least one of:
means for providing the higher emotional value the larger is the pupil diameter; and
means for providing the higher emotional value the larger is the eye size.

In an embodiment the apparatus the means for defining the emotional value for the frame comprises:
means for obtaining an emotional value Eᵢⱼ of a frame Fᵢ for a user Uᵢ (j=1, 2, . . . , M) by weighting the pupil diameter of the user by a first weight factor α, weighting the eye size of the user by a second weight factor β, and forming a sum of the results of the multiplications.

In an embodiment the apparatus further comprises:
means for normalizing the emotional value Eᵢⱼ of each user to obtain a normalized emotional value Eᵢⱼ′ for each user;
means for calculating an emotional value Eᵢ′ for each frame by summing the normalized emotional values and dividing the sum by the number of users; and
means for producing a general emotional sequence E for the video from the emotional values of the frames of the video.

In an embodiment the apparatus further comprises means for determining an object of interest from the key frame.

In an embodiment the apparatus further comprises:
means for obtaining information of one or more gaze points the user is looking at;
means for examining which object is located on the display at said one or more gaze points; and
means for selecting the object as the object of interest located at one or more of said gaze points.

In an embodiment the apparatus further comprises means for generating a personalized object-level video summary by using information of the objects of interest.

1-45. (canceled)

46. A method comprising:
displaying one or more frames of a video to a user;
obtaining information on an eye of the user;
using the information on the eye of the user to determine one or more key frames among the one or more frames of the video; and
using the information on the eye of the user to determine one or more objects of interest in the one or more key frames.

47. The method of claim 46, wherein obtaining information on an eye of the user comprises:
obtaining pupil diameter, gaze point and eye size for at least one frame of the video.

48. The method of claim 47 comprising:
using at least one of the pupil diameter, gaze point; eye size and an average of a size of both eyes to define an emotional value for the frame.

49. The method of claim 48 further comprising at least one of:
providing the higher emotional value the larger is the pupil diameter; and
providing the higher emotional value the larger is the eye size.

50. The method of claim 48, wherein defining the emotional value for the frame comprises:
obtaining an emotional value Eᵢⱼ of a frame Fᵢ for a user Uᵢ (j=1, 2, . . . , M) by weighting the pupil diameter of the user by a first weight factor α, weighting the eye size of the user by a second weight factor β, and forming a sum of the results of the multiplications.

51. The method according claim 50 further comprising:
normalizing the emotional value Eᵢⱼ of each user to obtain a normalized emotional value Eᵢⱼ′ for each user;
calculating an emotional value Eᵢ′ for each frame by summing the normalized emotional values and dividing the sum by the number of users; and
producing a general emotional sequence E for the video from the emotional values of the frames of the video.

52. The method of claim 46 comprising:
determining an object of interest from the key frame.

53. The method of claim 52 comprising:
obtaining information of one or more gaze points the user is looking at;
examining which object is located on the display at said one or more gaze points; and
selecting the object as the object of interest located at one or more of said gaze points.

54. The method of claim 53 comprising:
generating a personalized object-level video summary by using information of the objects of interest.

55. An apparatus comprising at least one processor and at least one memory including computer program code, the at least one memory and the computer program code configured to, with the at least one processor, causes the apparatus to:
display one or more frames of a video to a user;
obtain information on an eye of the user;
use the information on the eye of the user to determine one or more key frames among the one or more frames of the video; and
use the information on the eye of the user to determine one or more objects of interest in the one or more key frames.

56. The apparatus of claim 55, said at least one memory stored with code thereon, which when executed by said at least one processor, causes the apparatus to:
obtain pupil diameter, gaze point and eye size for at least one frame of the video.

57. The apparatus of claim 56, said at least one memory stored with code thereon, which when executed by said at least one processor, causes the apparatus to:
use at least one of the pupil diameter, gaze point; eye size and an average of a size of both eyes to define an emotional value for the frame.

58. The apparatus of claim 57, said at least one memory stored with code thereon, which when executed by said at least one processor, causes the apparatus to perform at least one of:
provide the higher emotional value the larger is the pupil diameter; and
provide the higher emotional value the larger is the eye size.

59. The apparatus of claim 55, said at least one memory stored with code thereon, which when executed by said at least one processor, causes the apparatus to define the emotional value for the frame by:
obtain an emotional value Eᵢⱼ of a frame Fᵢ for a user Uⱼ (j=1, 2, . . . , M) by weighting the pupil diameter of the user by a first weight factor α, weight the eye size of the user by a second weight factor β, and form a sum of the results of the multiplications.

60. The apparatus of claim 59, said at least one memory stored with code thereon, which when executed by said at least one processor, causes the apparatus to:
normalize the emotional value Eᵢⱼ of each user to obtain a normalized emotional value Eᵢⱼ′ for each user;
calculate an emotional value Eᵢⱼ for each frame by summing the normalized emotional values and dividing the sum by the number of users; and
produce a general emotional sequence E for the video from the emotional values of the frames of the video.

61. The apparatus of claim 55, said at least one memory stored with code thereon, which when executed by said at least one processor, causes the apparatus to:
determine an object of interest from the key frame.

62. The apparatus of claim 61, said at least one memory stored with code thereon, which when executed by said at least one processor, causes the apparatus to:
obtain information of one or more gaze points the user is looking at;
examine which object is located on the display at said one or more gaze points; and
select the object as the object of interest located at one or more of said gaze points.

63. The apparatus of claim 62, said at least one memory stored with code thereon, which when executed by said at least one processor, causes the apparatus to:
generate a personalized object-level video summary by using information of the objects of interest.

64. A computer program product embodied on a non-transitory computer readable medium, comprising computer program code configured to, when executed on at least one processor, causes an apparatus or a system to:
display one or more frames of a video to a user;
obtain information on an eye of the user;
use the information on the eye of the user to determine one or more key frames among the one or more frames of the video; and
use the information on the eye of the user to determine one or more objects of interest in the one or more key frames.

65. The computer program product of claim 64, said computer program code, which when executed by said at least one processor, causes the apparatus or system to:
obtain pupil diameter, gaze point and eye size for at least one frame of the video.
